(19) United States
(12) Patent Application Publication
(10) Pub. No.: US 2015/0216745 A1
(43) Pub. Date: Aug. 6, 2015

(54) NON-DISPOSABLE MEDICAL EQUIPMENT COVER AND METHOD OF APPLYING THE SAME

(71) Applicant: Gregory Christmas, Arcadia, CA (US)

(72) Inventor: Gregory Christmas, Arcadia, CA (US)

(21) Appl. No.: 14/477,708

(22) Filed: Sep. 4, 2014

Related U.S. Application Data
(60) Provisional application No. 61/935,702, filed on Feb. 4, 2014.
(60) Provisional application No. 62/000,467, filed on May 19, 2014.

(51) Int. Cl. A61G 1/01; B32B 38/10; B32B 38/04; B32B 37/18; B32B 37/12

(52) U.S. Cl. CPC A61G 1/01; B32B 37/18; B32B 37/12; B32B 38/04; B32B 38/10; B32B 2038/042; B32B 2479/00; B32B 2535/00

(57) ABSTRACT

A non-disposable medical device cover having an adhesive coating on one side of the cover and being to adhere to at least a spine board and a gurney mattress.

### CROSS-REFERENCE TO RELATED APPLICATION(S)

This application claims priority to and the benefit of both of co-pending U.S. Provisional Patent Application No. 61/935,702, filed on Feb. 4, 2014 in the U.S. Patent and Trademark Office, and co-pending U.S. Provisional Patent Application No. 62/000,467, filed on May 19, 2014 in the U.S. Patent and Trademark Office, the entire contents of both of which are hereby incorporated by reference.

### BACKGROUND

1. Field

Aspects of embodiments of the present invention are directed toward a cover for a spine board and a method for applying the cover to the spine board.

Aspects of embodiments of the present invention are also directed toward a cover for a gurney mattress and a method for applying the cover to the gurney mattress.

2. Description of Related Art

A spine board (e.g., a backboard or a long spine board) is often used by emergency medical personal to support and/or transport a patient. Spine boards are often utilized in pre-hospital trauma situations, such as at accident scenes or during emergency situations. Spine boards are intended to be used multiple times before they are discarded, and therefore, a spine board may come into contact with a plurality of patients during its lifetime.

A spine board is typically about 72 inches long and between about 16 inches and about 18 inches wide, however other, more specialized spine boards may have different dimensions. For example, a typical pediatric spine board is about 48 inches long and about 12 inches wide. Spine boards are typically between about 0.75 inches and about 2.5 inches thick. These dimensions are provided for reference only and are not to be construed as limiting. Spine boards are typically made of plastic or wood.

The spine board may also have a plurality of openings (e.g., holes or through holes) along a periphery of the spine board so that emergency medical personal can more easily handle and move the spine board. Further, straps may be coupled to the spine board at the openings of the spine board to better secure a patient on the spine board.

A gurney (e.g., a stretcher or wheeled stretcher) is often used by medical personal to support and transport a patient. Gurneys are used at both pre-hospital trauma situations (e.g., car accidents) to move patients from the scene to an ambulance and also in hospital situations to move patients to different rooms (e.g., operating rooms or recovery rooms). Specific gurneys are generally used in hospital and trauma situations. For example, hospital gurneys may be heavier and/or larger than trauma gurneys. Because trauma gurneys (e.g., ambulance gurneys) are intended to be used in trauma situations, they are generally lighter and/or smaller than hospital gurneys and include a collapsible undercarriage to be loaded into an ambulance.

Gurneys include separate gurney mattresses placed thereon which provide comfortable support to the patient laying thereon. Gurney mattresses are typically made of a foam inner surrounded by a vinyl cover. Gurney mattress are intended to be used multiple times before they are discarded and therefore, will come into contact with a plurality of patients during its lifetime.

Hospital gurney mattresses are typically between about 74 inches and 78 inches long, between about 24 inches and 30 inches wide, and between about 3 inches and 4 inches thick. Trauma gurney mattresses are typically about 72 inches long, about 18 inches wide, and between about 4.5 inches and 5 inches thick.

Because the spine board and the gurney mattress are often used in trauma situations (e.g., car accidents or surgery), patients may excrete bodily fluids onto the spine board and gurney mattress, such as blood, vomit, feces, urine, and the like. After use, the spine board and gurney mattress are cleaned and sterilized to remove the bodily fluids. However, the cleaning may not remove all of the bodily fluids, and some of the bodily fluids, germs, and/or bacteria may remain on the spine board and the gurney mattress. Recent studies have shown that almost all previously used spine boards have at least some bodily fluids, bacteria, or germs thereon even after being cleaned. In addition, fitted textile sheets or paper sheets are often utilized to cover a gurney mattress before a patient is placed thereon. However, these sheets do not prevent bodily fluid, germs, bacteria, and the like from coming into contact with the gurney mattress. Such a condition is exacerbated by the porous surfaces of the plastic or the wood that spine boards are made from and the vinyl that gurney mattresses are made from. Because the spine board and gurney mattress are each utilized multiple times, any bodily fluids, germs, and/or bacteria remaining on the spine board or on the gurney mattress after a use may transfer to a subsequent patient that is placed on that spine board or gurney mattress. This can cause an infection in the subsequent patient.

### SUMMARY

Aspects of embodiments of the present invention are direct toward a single-use, disposable medical furniture cover and a method of using the same. Additional aspects are directed toward an impermeable spine board cover that prevents bodily fluids, germs, and/or bacteria on a spine board from transferring therethrough to protect a patient on the spine board and toward an impermeable gurney mattress cover that prevents bodily fluids, germs, and/or bacteria on a gurney mattress from transferring therethrough to protect a patient on the gurney mattress.

One embodiment of the present invention provides a cover and spine board system including: a spine board having a length, a width, and a thickness; and a cover having a top surface and a bottom surface opposite to the top surface, the cover having a length greater than that of the spine board and a width greater than that of the spine board, wherein an adhesive coating is on the bottom surface of the cover.

The width of the cover may be greater than a combination of the width of the spine board and twice the thickness of the spine board.

The length of the cover may be greater than a combination of the length of the spine board and twice the thickness of the spine board.

The cover may include polyethylene.

The cover may have a thickness between 2 mils and 3 mils.

The adhesive coating may include a pressure-sensitive adhesive.

The spine board may have an opening extending from a top surface of the spine board to a bottom surface of the spine board that is opposite to the top surface, and the opening may be adjacent to a periphery of the spine board along a width or a length direction of the spine board.

The bottom surface of the cover may be adhered to the top surface of the spine board and the cover may extend over the opening of the spine board.

The cover may have an opening corresponding to the opening of the spine board.

A portion of the cover around the opening of the cover may be adhered to an inner surface of the opening of the spine board.

Straps may extend through the opening in the cover and the opening of the spine board.

The cover may include a material that can be punctured by a person's fingers or a cutting tool.

The adhesive coating may be on an entirety of the bottom surface of the cover.

Another embodiment of the present invention provides a method of covering a spine board having a length, a width, and a thickness, the method includes: positioning a cover over the spine board, the cover having a length greater than that of the spine board and a width greater than that of the spine board, and an adhesive coating on a surface of the cover; and adhering the surface of the cover having the adhesive coating to a first surface of the spine board.

The method may further include adhering the surface of the cover having the adhesive coating to an edge of the spine board and to a second surface of the spine board that is opposite to the first surface, and the edge of the spine board may extend along a periphery of the first and second surfaces of the spine board and may extend between the first and second surfaces of the spine board.

The method may further include puncturing the cover at an area corresponding to an opening in the spine board, and may include adhering a portion of the cover around the punctured portion to an inner surface of the opening.

The cover may be punctured by utilizing a person's fingers.

The cover may be punctured by utilizing a cutting tool.

The method may further include, before the positioning the cover, placing a back support between the cover and the spine board, and the back support may have a length that is less than that of the spine board and may have a width that is less than that of the spine board.

The method may further include removing the cover from the spine board by grabbing an edge of the cover at one side of the spine board, and may include pulling the edge of the cover from the one side of the spine board toward an opposite side of the spine board until the cover is completely separated from the spine board.

Another embodiment of the present invention provides a cover and a spine board system consisting of a spine board having a length, a width, and a thickness and a cover having a top surface and a bottom surface opposite to the top surface, the cover having a length greater than that of the spine board and a width greater than that of the spine board, wherein an adhesive coating is on the bottom surface of the cover.

Another embodiment of the present invention provides a cover and gurney mattress system including: a gurney mattress having a length, a width, and a thickness; and a cover having a top surface and a bottom surface opposite to the top surface, the cover having a length greater than that of the gurney mattress and a width greater than that of the gurney mattress, wherein an adhesive coating is on the bottom surface of the cover.

The width of the cover may be greater than a combination of the width of the gurney mattress and the thickness of the gurney mattress, and the length of the cover may be greater than a combination of the length of the gurney mattress and the thickness of the gurney mattress.

Another embodiment of the present invention provides a cover and a gurney mattress system consisting of a gurney mattress having a length, a width, and a thickness and a cover having a top surface and a bottom surface opposite to the top surface, the cover having a length greater than that of the gurney mattress and a width greater than that of the gurney mattress, wherein an adhesive coating is on the bottom surface of the cover.

### BRIEF DESCRIPTION OF THE DRAWINGS

The above and other features and aspects of the present invention will become more apparent by describing in detail example embodiments thereof with reference to the attached drawings, in which:

FIG. 1 is an exploded perspective view of a cover and a spine board according to an embodiment of the present invention;

FIG. 2 is a perspective view of the cover and the spine board shown in FIG. 1 in a joined state;

FIG. 3 is a perspective view of a portion of the cover and the spine board shown in FIG. 2 illustrating a person utilizing her hand to puncture the cover;

FIG. 4 is a perspective view of a portion of the cover and the spine board shown in FIG. 2 illustrating a cutting tool puncturing the cover;

FIG. 5 is a perspective view of the cover and the spine board shown in FIG. 2 in which straps are coupled to respective openings of the spine board;

FIG. 6 is a perspective view of the cover and the spine board shown in FIG. 5 in which a patient is on the cover and the spine board and secured by the straps;

FIG. 7 is a perspective view of the cover the spine board shown in FIG. 6 in which the cover is partially removed from the spine board;

FIG. 8 is a perspective view of a cover and the spine board shown in FIG. 7 in a separated state in which the cover is being discarded;

FIG. 9 is a exploded perspective view of a cover and a spine board with a back support between the cover and the spine board; and

FIG. 10 is a perspective view of the cover, the spine board, and the back support shown in FIG. 9 in a joined state.

FIG. 11 is an exploded view of a cover, gurney mattress, and gurney according to an embodiment of the present invention.

FIG. 12 is a perspective view of the cover and gurney mattress in a joined state on the gurney as shown in FIG. 11.

FIG. 13 is a perspective view of a cover and gurney mattress in a joined state on a gurney according to another embodiment of the present invention.

FIG. 14 is an exploded view of a cover and gurney mattress according to another embodiment of the present invention.

FIG. 15 is a perspective view of the cover and gurney mattress shown in FIG. 14 in which the cover is partially removed from the gurney mattress.

### DETAILED DESCRIPTION

The present invention will now be described more fully with reference to the accompanying drawings in which example embodiments of the invention are shown. In the drawings, thicknesses of elements may be exaggerated for clarity. Like reference numerals in the figures denote like elements throughout and redundant descriptions thereof may be omitted.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present. As used herein, the term “and/or” includes any and all combinations of one or more of the associated listed items. Further, the use of “may” when describing embodiments of the present invention relates to “one or more embodiments of the present invention.”

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing particular example embodiments only and is not intended to limit the example embodiments described herein. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

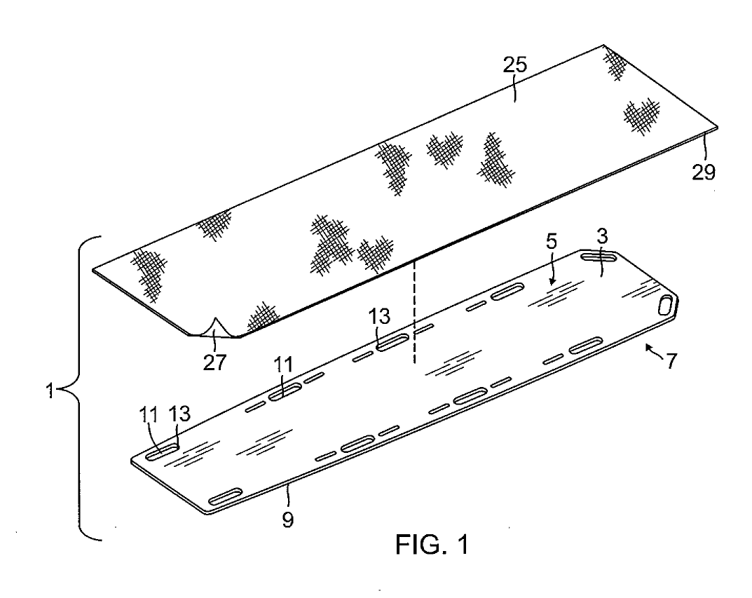

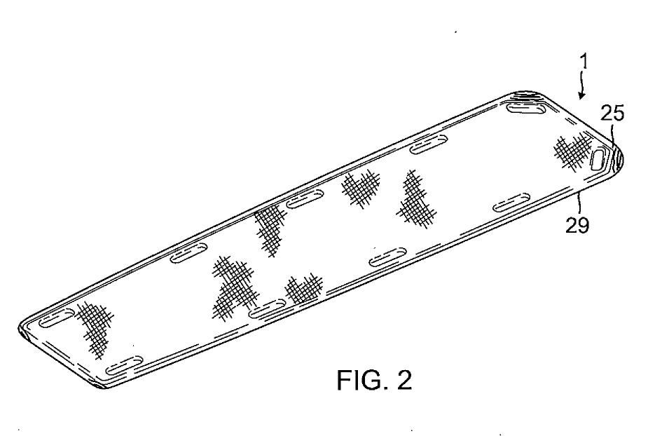

With reference to FIGS. 1 and 2, an embodiment of the present invention includes a cover 25 (e.g., a spine board cover or a backboard cover) and may further include a spine board 3 (e.g., a backboard). The cover 25 has a substantially rectangular shape with edges 29 along a periphery of the cover 25. One side of the cover 25 (e.g., a bottom side or a bottom surface of the cover) may have an adhesive coating 27 thereon. The adhesive coating 27 may be on an entirety of the one side of the cover 25. Another side of the cover 25 (e.g., a top side or a top surface of the cover) opposite to the one side may not have the adhesive coating thereon.

The spine board 3 may have a substantially planar top surface 5 (e.g., a top side) and a substantially planar bottom surface 7 (e.g., a bottom side) opposite to the top surface 5. The top and bottom surfaces 5 and 7 extend along a length and a width direction of the spine board 3. That is, the spine board 3 has a length and a width defined by the top and bottom surfaces 5 and 7. As used herein, the term substantially refers to normal variations that occur due to, for example, manufacturing tolerances. The top surface 5 and the bottom surface 7 are spaced from each other by a distance (e.g., a thickness), and a rim 9 extends between (e.g., connects) the top surface 5 and the bottom surface 7. The rim 9 extends along a periphery of each of the top surface 5 and the bottom surface 7.

The spine board 3 may have one or more openings 11 (e.g., holes or hand holes) therein that extend from the top surface 5 to the bottom surface 7. That is, the openings 11 may extend through the spine board 3. Each opening 11 may have a substantially rectangular center portion with rounded sides at the ends of longer sides of the rectangular center portion, for example, an elongated oval shape. An opening rim 13 is an inner surface of the opening 11. The openings 11 may be located at the periphery of the spine board 3 (e.g., may extend along and be offset from the rim 9) along opposite sides of the spine board 3 substantially parallel to the length direction of the spine board 3. However, the openings 11 may be at any area of the spine board 3.

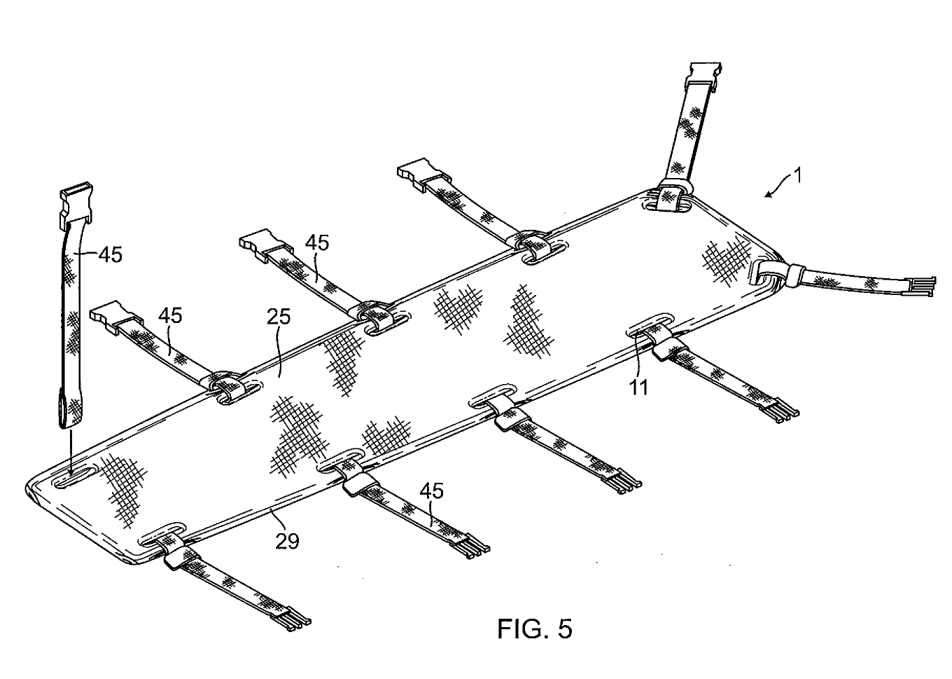

In use, the openings 11 may be utilized as hand holds or grab handles by emergency medical personal so that they may more easily handle the spine board 3, with and without a patient thereon. Therefore, each of the openings may be sized to allow a person's fingers to comfortably fit therethrough. The openings 11 may also be sized to allow straps and connectors to easily pass therethrough. The straps will be further described later (see FIG. 5).

The cover 25 is sized to be larger (e.g., slightly larger) than the spine board 3 (e.g., larger than a surface of the spine board 3). For example, the cover may be about 82 inches long and about 24 inches wide. However, the present invention is not limited thereto, and the cover 25 may have a length that is at least as long as a combination of the length of the spine board 3 and twice the thickness of the spine board 3. The cover 25 may have a width that is at least as wide as a combination of the width of the spine board 3 and twice the thickness of the spine board 3. As shown in FIG. 2, the cover 25 is located over (e.g., centered over) the spine board 3 (e.g., over the top surface 5 of the spine board 3) and is adhered to the spine board 3 by the adhesive coating 27 on the one side of the cover 25. Any excess material, that is, material that extends past the top surface 5 of the spine board 3, of the cover 25 may be adhered to the rim 9 and onto the bottom surface 7 of the spine board 3. The edges 29 of the cover 25 may be adhered to the bottom surface 7 of the spine board 3 such that the top surface 5 and the rim 9 of the spine board 3 is completely covered by the cover 25. The cover 25 may slightly extend into each of the openings 11 or may extend over the openings 11.

The overall dimensions of the spine board 3 (e.g., the width, the length, and the thickness of the spine board 3) are not substantially increased when the cover 25 is adhered to the spine board 3. Because the dimensions of the spine board 3 are not substantially increased when the cover 25 is adhered thereto, same storage and/or mounting locations or fixtures utilized for the spine board 3 can be utilized to store and/or mount the spine board 3 having the cover 25 thereon. Therefore, the cover 25 can be adhered to the spine board 3 prior to use, and the spine board 3 having the cover 25 can be stored as any spine board not having the cover 25 thereon would be stored.

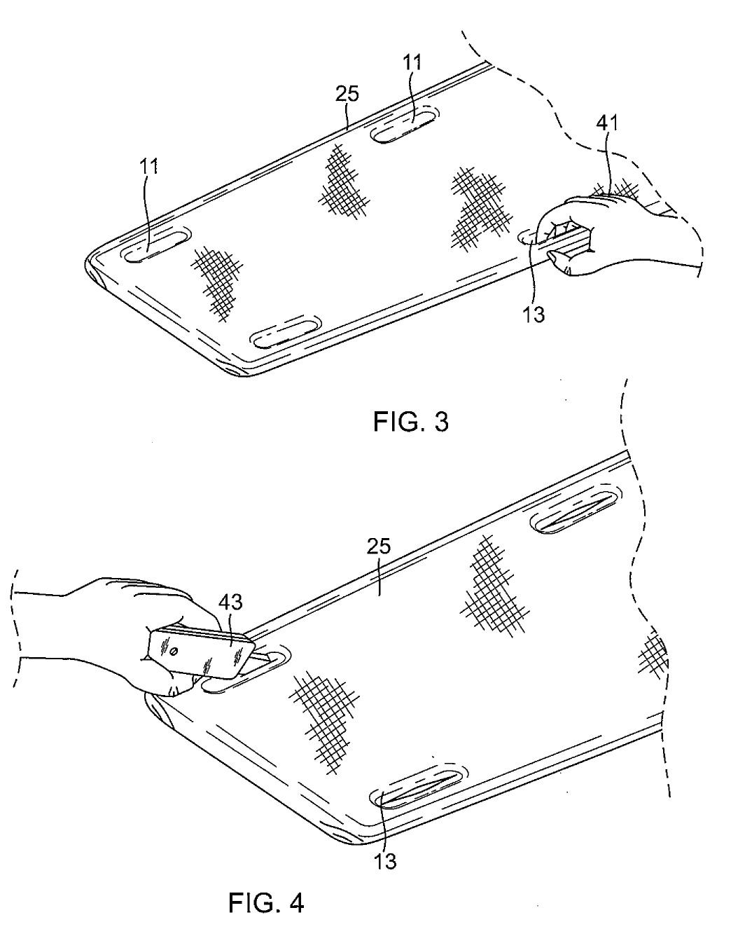

Referring to FIG. 3, after the cover 25 is adhered to the spine board 3, the user may want access to one or more of the openings 11. In such a case, the user can use her fingers 41 to puncture the cover 25 at an area corresponding to one or more of the openings 11. Once the cover 25 has been punctured at the opening 11, the user can press the cover 25 around a punctured portion thereof onto the corresponding opening rim 13, and the adhesive coating 27 on the one side of the cover 25 can be adhered to the corresponding opening rim 13. Therefore, even when the cover 25 is punctured at the openings 11, the patient on the spine board 3 will not come into direct contact with the spine board 3, even at the openings 11, thereby preventing the patient from coming into contact with any bodily fluid, germs, and/or bacteria remaining on the spine board 3 and preventing any of the patient's bodily fluids, germs, and/or bacteria from contacting the spine board 3.

Referring to FIG. 4, after the cover 25 is adhered to the spine board 3, the user may want access to one or more of the openings 11. In such a case, the user may use a cutting tool 43, such as a knife, to puncture the cover 25 at one or more of the openings 11. Once the user has punctured the cover 25, the user may push the cover 25 around the punctured portion thereof into the corresponding opening 11. The adhesive coating 27 on the one side of the cover 25 can be adhered to the corresponding opening rim 13, thereby preventing transfer of bodily fluid, germs, and/or bacteria between the patient and the spine board 3.

Referring to FIG. 5, when the user has punctured the cover 25 at one of more of the openings 11, such as described above, the user may couple straps 45 to the spine board 3 or to each straps 45 after the straps 45 are passed through the openings 11. The straps 45 may be coupled to the spine board 3 by, for example, extending one end of a strap 45 through the opening 11 corresponding to the punctured cover 25 and extending the one of the strap 45 through a loop at another end of the strap 45. The cover 25 does not interfere with the coupling of the straps 45 to the spine board 3 once the cover 25 is punctured at the openings 11, and the cover 25 continues to protect the patient and the spine board 3 even when the straps 45 are present.

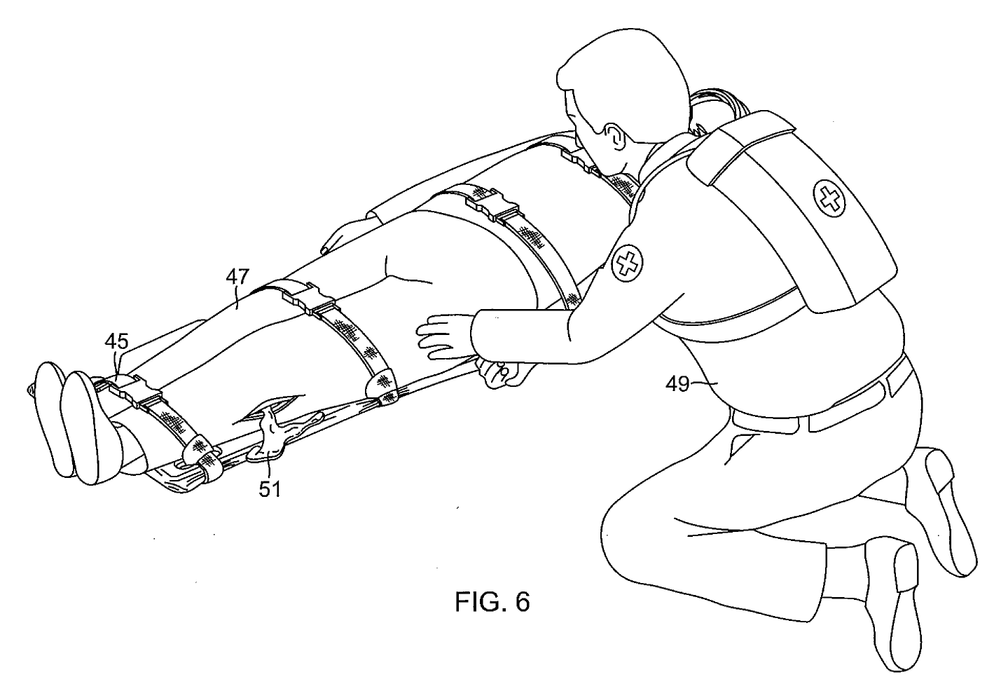

Referring to FIG. 6, an emergency medical technician or EMT 49 (e.g., a user) may place a patient 47 on the surface of the spine board 3 at which the cover 25 is adhered (e.g., the top surface 5 of the spine board 3). The EMT 49 may secure the patient 47 to the spine board 3 by utilizing the straps 45, however, this is not necessary. Due to the presence of the cover 25, even when the patient 47 is injured, for example, is bleeding, vomiting, excreting, or the like, any bodily fluids 51 will not contact the spine board 3. Further, because the cover 25 extends over the rim 9 and onto the bottom surface 7 of the spine board 3, any bodily fluids 51 exiting the patient 47 will not contact the spine board 3. Also, no bodily fluids, germs, and/or bacteria on the spine board 3 will contact the patient 47, such that contamination of or an infection in the patient 47 may be prevented.

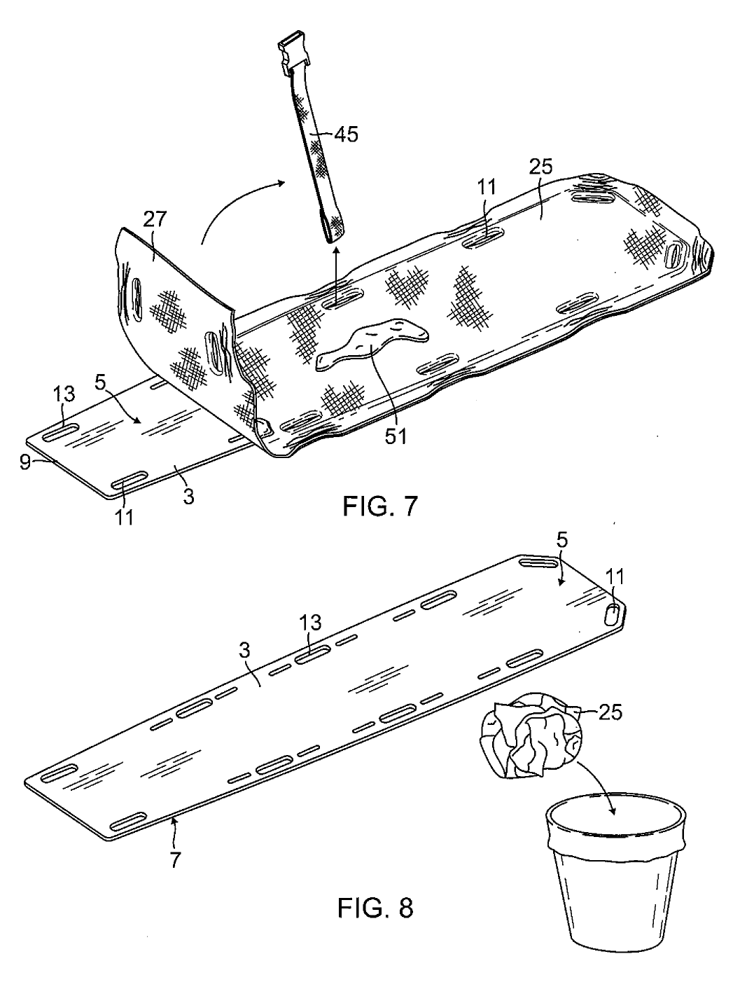

Referring to FIG. 7, the cover 25 may be easily removed from the spine board 3. When straps 45 are coupled to the spine board 3, the straps 45 should be removed prior to removing the cover 25. However, the straps 45 can remain coupled to the spine board 3, and the user can tear or cut the cover 25 at the edges 29 corresponding to the straps 45 so that the cover 25 can be removed around the straps 45. Further, no special tools are required to remove the cover 25 from the spine board 3, and the user may grab the edge 29 of the cover 25 and pull to remove the cover 25. When the cover 25 has been in contact with any bodily fluids or the patient, the user can carefully remove the cover 25 from the spine board 3 by grabbing the edge 29 of the cover 25 along the periphery of the spine board 3 and pulling the edges 29 such that any bodily fluids move to and pool at a center of the cover 25. Thereby the user can ensure bodily fluids do not contact the spine board 3 even during removal of the cover 25. Alternatively, the user may pull on the edge 29 from one end of the spine board 3 towards another end of the spine board 3 until the cover 25 is completely separated from the spine board 3.

Referring to FIG. 7, once the cover 25 has been removed from the spine board 3, the cover 25 can be disposed of by, for example, placing it in a waste basket specifically for medical waste. Because the cover 25 includes the flexible plastic material, the cover 25 can be rolled up into, for example, a ball shape with the surface of the cover 25 that was in contact with the patient 47 and bodily fluids 51 facing an inside of the ball shape, thereby ensuring the user and/or others do not come into contact with the bodily fluids, germs, and/or bacteria remaining on the used cover 25. Additionally, the cover 25 can be removed even when the patient 47 has not been in contact therewith. For example, the cover 25 can be removed from the spine board 3 at any time the patient 47 is not on the spine board 3, such as when the cover 25 has been adhered to the spine board 3 for an extended period of time without use or when the cover 25 becomes soiled due to some other reason.

The adhesive coating 27 does not leave any adhesive residue on the spine board 3 after removal. Therefore, even when the cover 25 has been adhered to the spine board 3, the spine board 3 can later be used without the cover 25 thereon without discomfort to the patient. Also, once the cover 25 has been removed from the spine board 3, another cover 25 may be adhered to the spine board 3 in the same manner as the cover 25 was adhered to the spine board 3. Thereby, the same spine board 3 may be used multiple times, each time providing a clean, sanitary surface to each patient that is placed on the spine board 3. Further, the cover 25 may be adhered to the spine board 3 prior to a trauma situation. That is, the user may adhere the cover 25 to the spine board 3 and place the spine board 3 in storage. Therefore, when the trauma situation occurs, the spine board 3 already has the cover 25 adhered thereto and the user does not have to take the time to adhere the cover 25 to the spine board 3 at or en route to a trauma scene. Alternatively, the cover 25 can be quickly and easily adhered to the spine board 3 at or en route to the trauma scene.

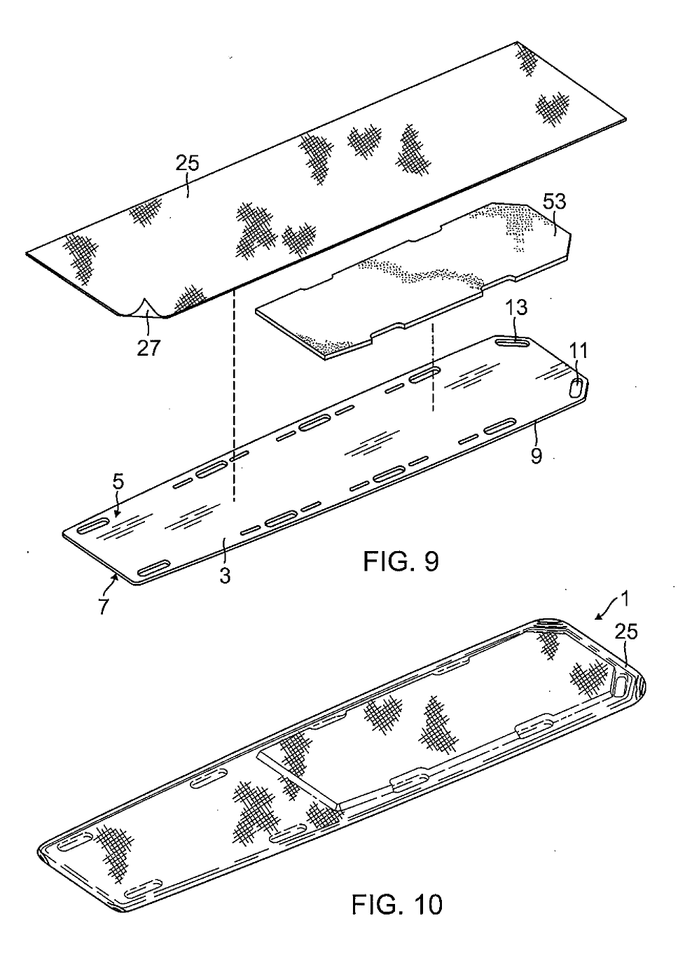

Referring to FIGS. 9 and 10, a back support 53 may be further included between the cover 25 and the spine board 3. The back support 53 can further support a patient's back and/or neck. The back support 53 has a length less than that of the spine board 3 and a width less than that of the spine board 3. The cover 25 and the spine board 3 may be substantially the same as described above, and the back support 53 will not interfere with the cover 25 as described above. That is, the cover 25 will adhere to and extend over both the spine board 3 and the back support 53. The cover 25 may be appropriately sized to cover both the back support 53 and the spine board 3 while still extending to the rim 9 of the spine board 3 and onto the bottom surface 7 of the spine board 3 as described above. Furthermore, the cover 25 prevents any transfer of bodily fluids, bacteria, and/or germs between the patient and the back support 53, such that the back support 53 may be used multiple times without being contaminated or contaminating the patient.

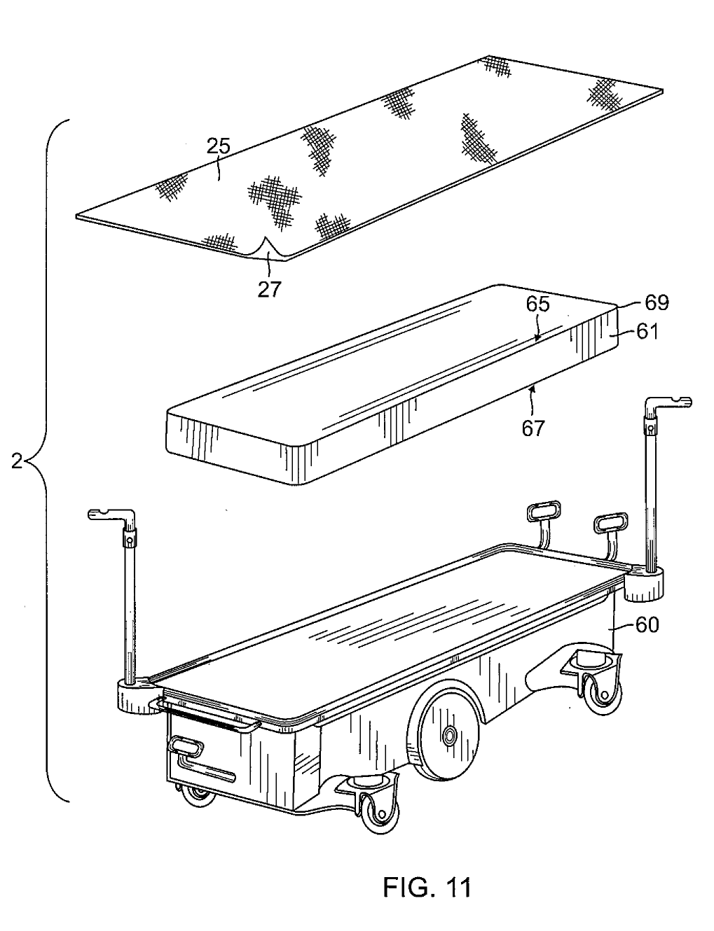

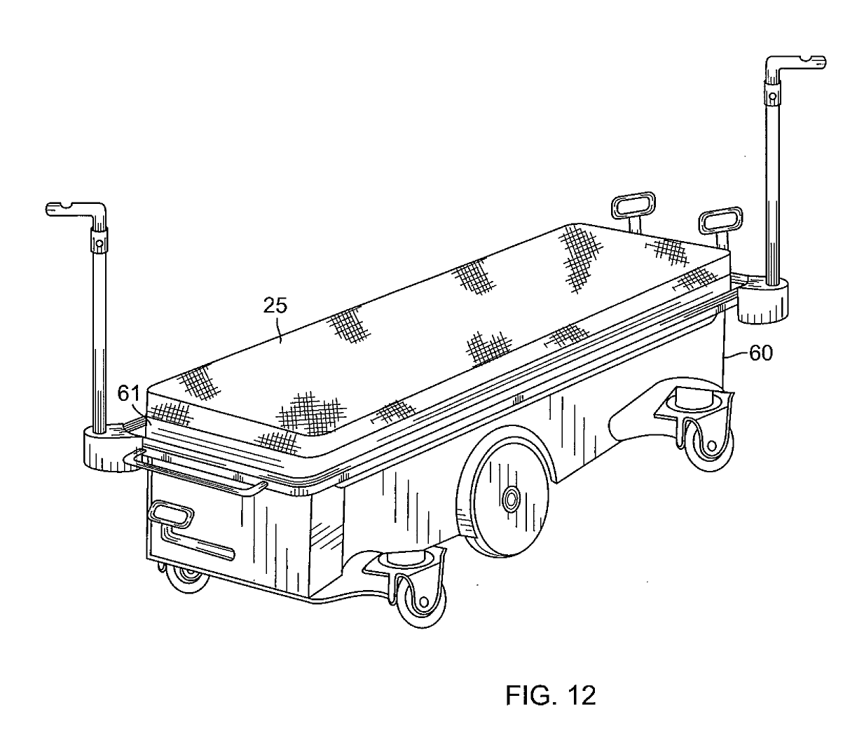

Referring to FIGS. 11 and 12, another embodiment of the present invention includes a cover 25 (e.g., a mattress cover or gurney mattress cover) and may further include a gurney mattress 61 and a gurney 60 (e.g., a hospital gurney). The cover 25 may be similar to the cover 25 referring to in the previous embodiments. The cover 25 has a substantially rectangular shape with edges 29 along a periphery of the cover 25. One side of the cover 25 (e.g., a bottom side or a bottom surface of the cover 25) may have an adhesive coating 27 thereon. Another side of the cover 25 (e.g., a top side or a top surface of the cover 25) opposite to the one side may not have an adhesive coating thereon.

The gurney mattress may have a top surface 65 (e.g., a top side) and a bottom surface 67 (e.g., a bottom side) opposite the top surface 65. The top and bottom surfaces 65 and 67 extend along a length and a width direction of the gurney mattress 61. That is, the gurney mattress has a length and a width defined by the top and bottom surfaces 65 and 67. The top surface 65 and the bottom surface 67 are spaced apart from each other by a distance (e.g., a thickness), and sides 69 extend between (e.g., connect) the top surface 65 and the bottom surface 67.

The cover 25 is sized to be larger (e.g., slightly larger) than the gurney mattress 61 (e.g., larger than a surface of the gurney mattress 61). For example, the cover 25 may be about 82 inches long and about 24 inches wide. In another embodiment, the cover 25 may be about 84 inches long and about 34 inches wide. However, the present invention is not limited thereto, and the cover 25 may have a length that is at least as long as the length of the gurney mattress 61 and a width that is at least as wide as the width of the gurney mattress 61. As shown in FIG. 12, the cover 25 is located over (e.g., centered over) the gurney mattress 61 (e.g., over the top surface 65 of the gurney mattress 61) and is adhered to the gurney mattress 61 by the adhesive coating 27 on the one side of the cover 25. Any excess material, that is, material that extends past the top surface 65 of the gurney mattress 61, of the cover 25 may be adhered to the sides 69 of the gurney mattress 61. The edges 29 of the cover 25 may end at (e.g., may be at) the sides 69 of the gurney mattress 61 such that the top surface 65 and at least a top portion of the sides 69 of the gurney mattress 61 are covered by the cover 25.

The overall dimensions of the gurney mattress 61 (e.g., the width, the length, and the thickness of the gurney mattress 61) are not substantially increased when the cover 25 is adhered thereto. Because the dimensions of the gurney mattress 61 are not substantially increased when the cover 25 is adhered thereto, a same gurney 60 utilized for a certain gurney mattress 61 can be utilized with that same gurney mattress 61 having the cover 25 thereon.

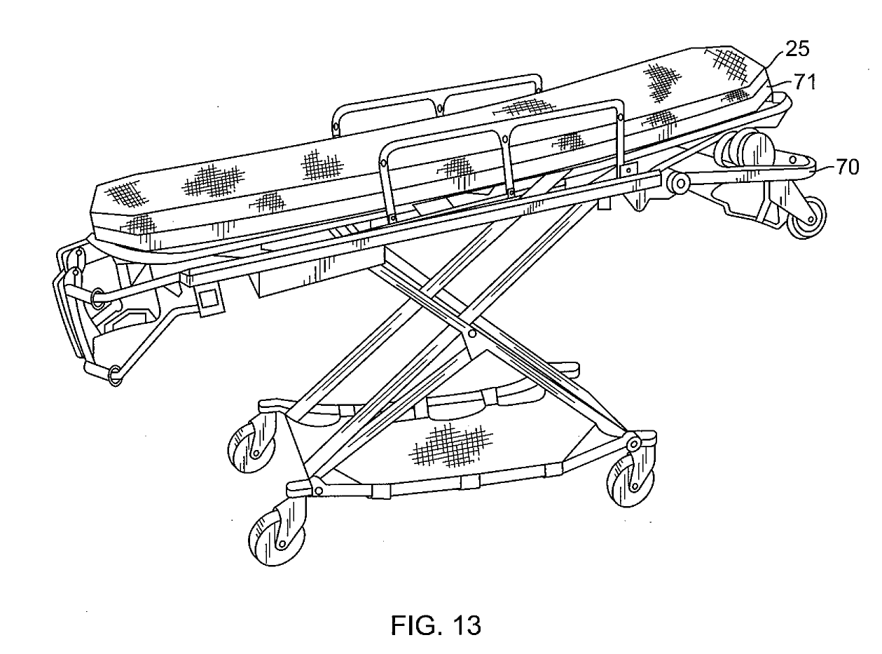

Referring to FIG. 13, the cover 25 may be applied to a gurney mattress 71 designed for a trauma gurney 70 (e.g., an ambulance gurney). The trauma gurney 70 differs from the gurney 60 in that it is designed to be used at a trauma scene (e.g., a car accident) and has a collapsible undercarriage. Furthermore, the trauma gurney 70 may be smaller than the gurney 60 such that the gurney mattress 71 may be smaller (e.g., may have a smaller length, width, and/or thickness) than the gurney mattress 61. Also, the corners (e.g., all four corners) of the gurney mattress 71 may be cut (e.g., may extend at an angle relative to the length and width directions of the gurney mattress 71). The cover 25 can adhere to the cut corners of the gurney mattress 71 as well as the square corners of the gurney mattress 61.

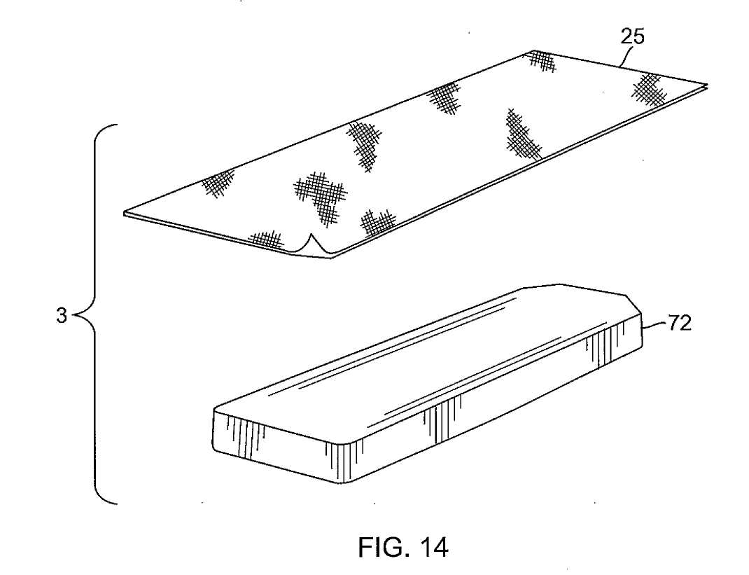

Referring to FIG. 14, a gurney mattress 72 may have only two cut corners and two square corners. The cover 25 can also adhere to the gurney mattress 72 having two cut corner and two square corners.

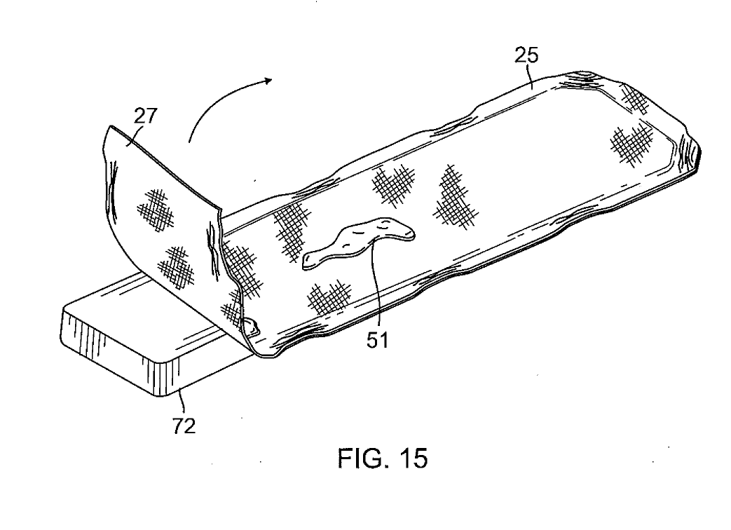

Referring to FIG. 15, the cover 25 may be easily removed from the gurney mattress 72.

No special tools are required to remove the cover 25 from the gurney mattress 72, and a user may grab the edge 29 of the cover 25 and pull to remove the cover 25. When the cover 25 has been in contact with any bodily fluids 51 or the patient, the user can carefully remove the cover 25 from the gurney mattress 72 by grabbing the edge 29 of the cover 25 along the periphery of the gurney mattress 72 and pulling the edge 29 such that any bodily fluids 51 move to and pool at a center of the cover 25. Thereby the user can ensure that bodily fluids 51 do not contact the gurney mattress 72 even during removal of the cover 25. Alternatively, the user may pull on the edge 29 from one end of the spine board 3 towards another end of the gurney mattress 72 until the cover 25 is completely separated from the gurney mattress 72.

The adhesive coating 27 does not leave any adhesive residue on the gurney mattress 72 after removal. Therefore, even when the cover 25 has been adhered to the gurney mattress 72, the gurney mattress 72 can later be used without the cover 25 thereon without discomfort to the patient. Also, once the cover 25 has been removed from the gurney mattress 72, another cover 25 may be adhered to the gurney mattress 72 in the same manner as the cover 25 was adhered to the gurney mattress 72. Thereby, the same gurney mattress 72 may be used multiple times, each time providing a clean, sanitary surface to each patient on the gurney mattress 72. Further, the cover 25 may be adhered to the gurney mattress 72 prior to use. That is, the user may adhere the cover 25 to the gurney mattress 72 and place the gurney mattress 72 in storage. Therefore, when the trauma situation occurs or when the gurney 60 is required to, for example, move a patient, the gurney mattress 72 already has the cover 25 adhered thereto and the user does not have to take the time to adhere the cover 25 to the gurney mattress 72. Alternatively, the cover 25 can be quickly and easily adhered to the gurney mattress 72 at or en route to the trauma scene or just prior to placing the patient thereon.

The cover 25 may include a flexible plastic material, for example, polyvinyl chloride, polyethylene (e.g., low density polyethylene), etc. The cover 25 may be, for example, between about 2.0 mil and about 3.0 mil thick. The cover 25 may be clear so that any damage to the spine board 3 or the gurney mattress 61, 71, 72 is visible through the cover 25. Further, the plastic material is also impermeable to bodily fluids, germs, and/or bacteria and, therefore, any bodily fluids, germs, and/or bacteria on the spine board 3 or the gurney mattress 61, 71, 72 may not be transmitted through the cover 25 or from the surface of the cover 25 to the spine board 3 or to the gurney mattress 61, 71, and 72. The plastic material may have a strength such that a user may puncture the plastic material with her fingers or with a cutting tool (see FIGS. 3 and 4).

The adhesive coating 27 can be any adhesive that adheres to the material of the spine board 3 (e.g., plastic or wood) or to the material of the gurney mattress 61, 71, 72 (e.g., vinyl). For example, the adhesive coating 27 may be a pressure-sensitive adhesive (PSA). For example, the adhesive coating 27 may be a water-based acrylic adhesive. The adhesive coating 27 may not adhere to (e.g., may not strongly adhere to) the cover 25 such that the bottom surface of the cover 25 having the adhesive coating 27 will not strongly adhere to the top surface of the cover 25. For example, when the bottom surface of the cover 25 having the adhesive coating 27 thereon adheres to the top surface of the cover 25, the user can easily pull the top and the bottom surfaces of the cover 25 apart without damaging the cover 25.

The cover 25 may be formed (e.g., manufactured) as a long sheet of the plastic material having the adhesive coating on one side thereof. A perforated portion may be at regular interval of the long sheet corresponding to the length of the cover 25. The long sheet may be in a roll so that a plurality of covers 25 may be compact and easily shipped. As needed, the user may roll out a single cover from the roll of covers and separate the cover at the perforated portion, thereby providing the cover 25 to be adhered to the spine board 3 or to the gurney mattress 61, 71, 72 while the remaining covers 25 remain part of the roll. However, the cover 25 may be individually formed.

While the present invention has been particularly shown and described with reference to some example embodiments thereof, it will be understood by those of ordinary skill in the art that various changes in form and details may be made therein without departing from the spirit and scope of the present invention as set forth in the following claims and their equivalents.

What is claimed is:

1. A cover and spine board system comprising:
a spine board having a length, a width, and a thickness; and
a cover having a top surface and a bottom surface opposite to the top surface, the cover having a length greater than that of the spine board and a width greater than that of the spine board,
wherein an adhesive coating is on the bottom surface of the cover.

2. The system of claim 1, wherein the width of the cover is greater than a combination of the width of the spine board and twice the thickness of the spine board.

3. The system of claim 1, wherein the length of the cover is greater than a combination of the length of the spine board and twice the thickness of the spine board.

4. The system of claim 1, wherein the cover comprises polyethylene.

5. The system of claim 1, wherein the cover has a thickness between 2 mils and 3 mils.

6. The system of claim 1, wherein the adhesive coating comprises a pressure-sensitive adhesive.

7. The system of claim 1, wherein the spine board has an opening extending from a top surface of the spine board to a bottom surface of the spine board that is opposite to the top surface and
wherein the opening is adjacent to a periphery of the spine board along a width or a length direction of the spine board, and
wherein the bottom surface of the cover is adhered to the top surface of the spine board and the cover extends over the opening of the spine board.

8. The system of claim 7, wherein the cover has an opening corresponding to the opening of the spine board, and
wherein a portion of the cover around the opening of the cover is adhered to an inner surface of the opening of the spine board.

9. The system of claim 8, wherein straps extend through the opening in the cover and the opening of the spine board.

10. The system of claim 1, wherein the cover comprises a material that can be punctured by a person's fingers or a cutting tool.

11. The system of claim 1, wherein the adhesive coating is on an entirety of the bottom surface of the cover.

12. A method of covering a spine board having a length, a width, and a thickness, the method comprising:
positioning a cover over the spine board, the cover having a length greater than that of the spine board and a width greater than that of the spine board, and an adhesive coating on a surface of the cover; and
adhering the surface of the cover having the adhesive coating to a first surface of the spine board.

13. The method of claim 12, further comprising:
adhering the surface of the cover having the adhesive coating to an edge of the spine board and to a second surface of the spine board that is opposite to the first surface,
wherein the edge of the spine board extends along a periphery of the first and second surfaces of the spine board and extends between the first and second surfaces of the spine board.

14. The method of claim 12, further comprising:
puncturing the cover at an area corresponding to an opening in the spine board; and
adhering a portion of the cover around the punctured portion to an inner surface of the opening.

15. The method of claim 14, wherein the cover is punctured by utilizing a person's fingers.

16. The method of claim 14, wherein the cover is punctured by utilizing a cutting tool.

17. The method of claim 12, further comprising:
before the positioning the cover, placing a back support between the cover and the spine board,
wherein the back support has a length that is less than that of the spine board and a width that is less than that of the spine board.

18. The method of claim 12, further comprising:
removing the cover from the spine board by grabbing an edge of the cover at one side of the spine board; and
pulling the edge of the cover from the one side of the spine board toward an opposite side of the spine board until the cover is completely separated from the spine board.

19. A cover and gurney mattress system comprising:
a gurney mattress having a length, a width, and a thickness; and
a cover having a top surface and a bottom surface opposite to the top surface, the cover having a length greater than that of the gurney mattress and a width greater than that of the gurney mattress, wherein an adhesive coating is on the bottom surface of the cover.

20. The system of claim 19, wherein the width of the cover may be greater than a combination of the width of the gurney mattress and the thickness of the gurney mattress, and the length of the cover may be greater than a combination of the length of the gurney mattress and the thickness of the gurney mattress.
